(19) United States
(12) Patent Application Publication
(10) Pub. No.: US 2005/0045366 A1
(43) Pub. Date: Mar. 3, 2005

(54) Power cord having one or more flexible carbon material sheathings

(76) Inventor: Michael Wolff, Renton, WA (US)

Correspondence Address: THOMAS E. LOOP;BARNARD, LOOP & MCCORMACK, 947 POWELL AVENUE SW, SUITE 105, RENTON, WA, 98055, US

(21) Appl. No.: 10/647,500

(22) Filed: Aug. 25, 2003

(51) Int. Cl. H01B 11/02

(52) U.S. Cl. 174/113 R

(57) ABSTRACT

A power cord adapted for the transmission of an alternating electrical current used to power electronic devices such as, for example, audio or video devices commonly used in residential homes and commercial business is disclosed herein. In one embodiment, the power cord comprises at least first, second, and third wires of substantially the same length, wherein each of the at least first, second, and third wires has a surrounding flexible carbon material sheathing. It is believed that the carbon material sheathing mitigate radio frequency interference (RFI) and electromagnetic interference (EMI).

### TECHNICAL FIELD

The present invention relates generally to power cords and, more specifically, to power cords that comprise one or more flexible carbon material sheathings, as well as power cords that comprise one or more carbon fiber or graphite conductive elements.

### BACKGROUND OF THE INVENTION

Power cords are commonly used to power audio and video equipment for home and commercial uses. A typical power cord consists essentially of three bundled wires of substantially the same length, wherein each wire or central conductive element or core is surrounded by an insulation or dielectric layer. The insulated wires, in turn, are generally surrounded by an outer protective flexible sheathing and are connected at one end to a three-pin male connection plug and at the other to a three-pin female connection plug. In this configuration, an alternating current (AC) is capable of being transmitted from a power source to a selected electronic device. There are, however, very few commercially available power cords that include shielding to dissipate or reflect radio frequency interference (RFI) and/or electromagnetic interference (EMI).

As is appreciated by those skilled in the art, electrical interference, or noise, is an unwanted electrical signal that can cause intolerable error or distortion in an electronic device. Interference or electrical noise is generally broken down into two somewhat overlapping categories: radio frequency interference (RFI) and electromagnetic interference (EMI). Some of the more commonly encountered sources of interference include radio, television and hand-held (i.e., walkie-talkie) transmitters, cellular phones, fluorescent lights, induction heating systems, transformers, and the like.

Of the few commercially available power cords that include RFI/EMI shielding, the shielding material typically consists essentially of a flexible metallic braided material sleeve that surrounds the bundle of three insulated wires. The braided material is typically made of copper, stainless steel or other similar ferrite material. Although these shielding materials tend to reduce electronic noise to some degree, they do not adequately address the issue of RFI and EMI associated with powering audio and video equipment for home and commercial uses.

Accordingly, there is a need in the art for new and improved power cords, as well as to methods relating to the same. The present invention fulfills these needs and provides for further related advantages.

### SUMMARY OF THE INVENTION

In brief, the present invention is directed to a power cord adapted for the transmission of an alternating electrical current used to power electronic devices such as, for example, audio or video devices commonly used in residential homes and commercial businesses. It is believed that the power cords of the present invention significantly improves sonic performance of such electronic devices by reducing radio frequency interference (RFI) and electromagnetic interference (EMI).

In one embodiment, a power cord in accordance with the present invention is adapted for the transmission of an alternating electrical current and comprises at least first, second, and third wires of substantially the same length, wherein each of the at least first, second, and third wires terminate so as to define first and second ends of the power cord, and wherein at least one of the at least first, second, and third wires has a first flexible carbon material sheathing. The alternating electrical current may have a frequency of about 50 hertz or of about 60 hertz, depending on the source of the supplied electrical current. The first, second, and third wires typically have an AWG gauge ranging from about 10 to 14, and preferably of about 12. Moreover, the first, second, and third wires may be made of aluminum, copper, silver, gold, or carbon.

In further embodiments, the power cord may further comprise a second flexible carbon material sheathing, wherein at least one of the at least first, second, and third wires not having the first flexible carbon material sheathing has the second flexible carbon material sheathing. In still further embodiments, the power cord may still further comprise a third flexible carbon material sheathing, wherein at least one of the at least first, second, and third wires not having the first or second flexible carbon material sheathing has the third flexible carbon material sheathing. The first, second, and third wires may optionally be retained by a flexible plastic tube (of substantially the same length as the first, second, and third wires) such as, for example, a vinyl tube, which, in turn, may optionally be covered with a fourth flexible carbon material sheathing as well as an outer flexible nylon sheathing. In other embodiments, a three-pin male connection plug is connected at the first end of the power cord, whereas a three-pin female connection plug is connected at the second end of the power cord.

These and other aspects of the present invention will be evident upon reference to the following detailed description and related drawings.

### BRIEF DESCRIPTION OF THE DRAWINGS

Like reference numerals are used to designate like parts throughout the several views of the drawings, and:

FIG. 1 is a fragmentary pictorial view of a power cord in accordance with an embodiment of the present invention.

FIG. 2 is a fragmentary side view of a power cord in accordance with an embodiment of the present invention.

FIG. 3 is a cross sectional view taken along line 3-3 of the power cord shown in FIG. 2.

### DETAILED DESCRIPTION OF THE INVENTION

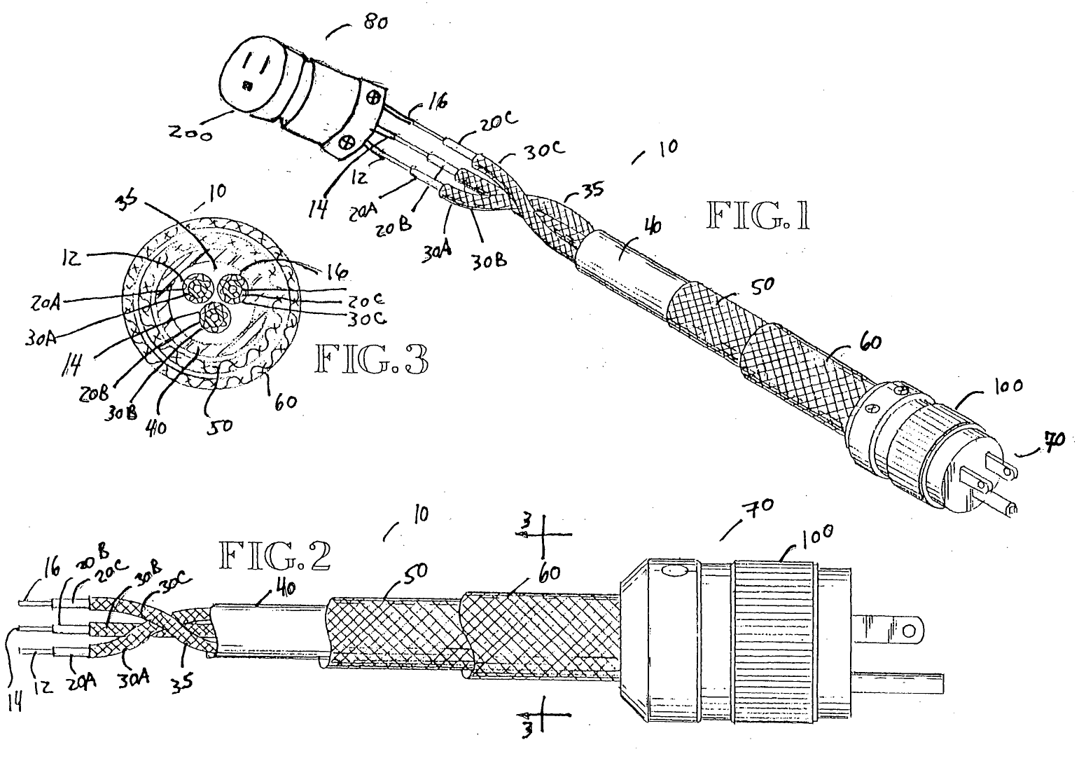

Referring to FIGS. 1-3, the present invention is directed to a power cord 10 adapted for the transmission of an alternating electrical current. Any type of alternating electrical current used to power household or commercial electrical devices may be transmitted by power cord 10 of the present invention. In some embodiments, the alternating electrical current may have a frequency of about 50 hertz or of about 60 hertz, depending on the source of the electrical current supplied.

The power cord 10 preferably includes first, second, and third wires 12, 14, and 16 that are substantially the same in terms of length. Each of the first, second, and third wires 12, 14, and 16 are made of a conductive material such as, for example, aluminum, copper, silver, gold or carbon (with copper and carbon being preferable). Wires 12, 14, and 16 may include wires of any diameter used to transmit alternating electrical current including wires with an American Wire Gauge (AWG) value ranging from about 10 to about 14. Preferably wires with an AWG value of about 12 are used.

Those of ordinary skill in the art will appreciate that wires 12, 14, and 16 may be constructed from a single strand of conductive material or any combination of multiple strands of conductive material known in the art. It is similarly appreciated by those of ordinary skill in the art that each of the three wires 12, 14, and 16, may include a plurality of wires and that such plurality of wires may be twisted, braided, or otherwise bundled together. For example, in one embodiment, wires 12 and 14 each include two individual wires twisted together in a twisted pair type arrangement.

Optionally, an insulation or dielectric jacket 20 known in the art may be used to cover the outer surface along the length of wires 12, 14, and 16 or any of the component strands of wires 12, 14, and 16. In the embodiment depicted in FIGS. 1-3, wires 12, 14, and 16 include insulation jackets 20A, 20B, and 20C, respectively At least one of the first, second, and third wires 12, 14, and 16 has a flexible carbon material sheathing 30 longitudinally covering a portion of the outer surface of the wire. It is believed that the inclusion of flexible carbon material sheathing in power cord 10 improves the sonic performance of electronic devices by reducing radio frequency interference (RFI) and electromagnetic interference (EMI). In the embodiment illustrated in FIGS. 1-3, all three wires 12, 14, and 16 have a flexible carbon material sheathing 30A, 30B, and 30C, respectively. Flexible carbon material sheathing 30 may have a thickness of approximately 0.001 to 0.025 inches and is preferably 0.012 inches.

In one embodiment, the flexible carbon material sheathing 30 includes a woven or braided carbon fiber. The braided carbon fiber may be manufactured into a hollow tube or sleeve through which wires 12, 14, and 16 may pass. The diameter of the hollow tub is determined as a function of the diameter of the wires to be sheathed therein. In embodiments using wires 12, 14, and 16 with an AWG value of 12, the hollow tube or sleeve may have a diameter of approximately 0.125 to 1.0 inches and preferably about 0.5 inches. A braided carbon fiber suitable for use with the present invention includes a braided carbon sleeve available from Composite Structures Technology, Tehachapi, Calif.

Wires 12, 14. and 16 and the flexible carbon material sheathing 30 included therewith may be bundled, twisted, braided, or woven into a bundle 35 of any type known in the art. Bundle 35 is provided herein as a non-limiting example of a bundle for use with the present invention. Those of ordinary skill in the art will readily appreciate that alternate arrangements of wires 12, 14, and 16 will produce alternate embodiments of bundle 35 within the scope of the present invention.

Wires 12, 14. and 16 may be retained within a flexible plastic tube 40. Flexible plastic tube 40 may be constructed from any suitable flexible plastic and is preferably constructed from vinyl. Flexible plastic tube 40 should have an inside diameter sufficiently large to receive wires 12, 14, and 16 and any flexible carbon material sheathing 30 included therewith. In an embodiment wherein wires 12, 14, and 16 have an AWG value of 12, flexible plastic tube 40 may have an outer diameter of approximately 0.25 to 1.25 inches and preferably about 0.75 inches.

Wires 12, 14, and 16 may be retained together within a flexible carbon material sheathing 50. In the embodiment depicted in FIGS. 1-3, wires 12, 14, and 16 are retained within flexible plastic tube 40 and flexible plastic tube 40 is retained within flexible carbon material sheathing 50. In alternate embodiments, wires 12, 14, and 16 may be retained within flexible carbon material sheathing 50 and flexible carbon material sheathing 50 may in turn be retained within flexible plastic tube 40. Flexible carbon material sheathing 50 may be constructed from the same materials used to construct flexible carbon material sheathing 30. Flexible carbon material sheathing 50 should be suitably sized to receive wires 2, 14, and 16 and flexible carbon material sheathing 30 therein. In some embodiments, flexible carbon material sheathing 50 should be appropriately sized to accommodate flexible plastic tube 40 therein. In some embodiments including wires 12, 14, and 16 with an AWG value of 12, flexible carbon material sheathing 50 includes a hollow tube or sleeve that may have a diameter of approximately 0.5 to 1.5 inches and preferably about one inch.

The embodiment depicted in FIGS. 1-3 includes an outer flexible nylon sheathing 60 in which wires 12, 14, and 16 are retained. In embodiments including either the flexible plastic tube 40 or flexible carbon material sheathing 50, such components should also be retained within the outer flexible nylon sheathing 60. Outer flexible nylon sheathing 60 may be generally tubular in shape allowing wires 12, 14, and 16 to pass therethrough unimpeded. In one embodiment, the outer flexible nylon sheathing 60 includes woven or braided nylon fiber. The braided nylon fiber may be manufactured into a hollow tube or sleeve. In embodiments of the present invention wherein wires 12, 14, and 16 have an AWG value of 12, the hollow tube or sleeve may have a diameter of approximately 0.5 to 1.5 inches and preferably about one inches.

End 70 of wires 12, 14, and 16 may be operationally coupled to a three-pin male connection plug 100. In this manner, the three-pin male connection plug 100 of power cord 10 may be received into a standard three-pin female connection plug or receptacle so that alternating electrical current may be transmitted across the male-female connection.

Referring to FIG. 1, end 80 of wires 12, 14, and 16 may be operationally coupled to a three-pin female connection plug 200. In this manner, the three-pin female connection plug of power cord 10 may be received a standard three-pin male connection plug so that alternating electrical current may be transmitted across the male-female connection.

Alternatively, end 80 of the wires 12, 14, and 16 may be operationally coupled to the circuitry of an electronic device (not shown). In this manner, power cord 10 may be “hard wired” to the electronic device for the purposes of supplying power directly to the electronic device. In such an embodiment, end 70 of wires 12, 14, and 16 may be operationally coupled to a three-pin male connection plug 100.

The present invention may be constructed by first selecting wires 12, 14, and 16. Then, one or more of wires 12, 14, and 16 are inserted into flexible carbon material sheathing 30. In embodiments wherein the flexible carbon material sheathing 30, includes a woven or braided carbon fiber, the edges of the flexible carbon material sheathing 30 may be taped to wires 12, 14, and 16 preferably at a location spaced from the ends 70 and 80 of the wires 12, 14, and 16, or otherwise prevented from unraveling via any method known in the art.

Optionally, wires 12, 14, and 16 and the flexible carbon material sheathing 30 included therewith may be bundled in any manner discussed above using methods known in the art. After one or more of the wires 12, 14, and 16 have been sheathed in flexible carbon material sheathing 30, the wires 12, 14, and 16 may be included in power cord assemblies disclosed herein or known in the art.

In one embodiment of power cord 10, wires 12, 14, and 16 and any flexible carbon material sheathing 30 included therewith are inserted into flexible plastic tube 40. Then, flexible plastic tube 40 and any components contained therein, is inserted into flexible carbon material sheathing 50. In alternate embodiments, wires 12, 14, and 16 are inserted into flexible carbon material sheathing 50. In this alternate embodiment, flexible carbon material sheathing 50 and any components contained therein may be inserted into flexible plastic tube 40. Then, depending upon the configuration of the embodiment being constructed, either flexible plastic tube 40 or flexible carbon material sheathing 50, whichever is outermost, is inserted into outer flexible nylon sheathing 60.

End 70 of wires 12, 14, and 16 of power cord 10 may be operationally coupled to a three-pin male connection plug 100. End 80 of wires 12, 14, and 16 of power cord 10 may be operationally coupled to either a three-pin female connection plug 200 or the circuitry of an electronic device (not shown).

It is readily appreciated by persons of ordinary skill in the art that length of power cord 10 is determined by the application for which it is used. Additionally, power cord 10 may be manufactured in either custom or standard lengths well known in the art.

Although the power cord of the present invention has been described in the context of the embodiments illustrated and disclosed herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalents are to be embraced within their scope.

1. A power cord configured to transmit an alternating electrical current, consisting essentially of a first, second, and third carbon conducting wires of substantially the same length, wherein each of the first, second, and third carbon conducting wires terminate so as to define first and second ends of the power cord, and wherein at least one of the first, second, and third carbon conducting wires has a first flexible carbon material sheathing.

2. The power cord of claim 1 wherein the alternating electrical current has a frequency of about 50 hertz.

3. The power cord of claim 1 wherein the alternating electrical current has a frequency of about 60 hertz.

4. The power cord of claim 1 wherein each of the first, second, and third carbon conducting wires has an AWG gauge ranging from about 10 to 14.

5. The power cord of claim 1 wherein each of the first, second, and third carbon conducting wires has an AWG gauge of about 12.

6. (canceled)

7. The power cord of claim 1, further comprising a second flexible carbon material sheathing, wherein at least one of the first, second, and third carbon conducting wires not having the first flexible carbon material sheathing has the second flexible carbon material sheathing.

8. The power cord of claim 1, further comprising a third flexible carbon material sheathing, wherein at least one of the first, second, and third carbon conducting wires not having the first or second flexible carbon material sheathing has the third flexible carbon material sheathing.

9. The power cord of claim 1 wherein the first flexible carbon material sheathing is made of a braided carbon fiber.

10. The power cord of claim 1, further comprising a flexible plastic tube, wherein the flexible plastic tube retains the first, second, and third carbon conducting wires.

11. The power cord of claim 10 wherein the flexible plastic tube is made of vinyl.

12. (canceled)

13. (canceled)

14. The power cord of claim 13, further comprising an outer flexible nylon sheathing, wherein the outer flexible nylon sheathing retains the fourth flexible carbon material sheathing.

15. The power cord of claim 1, further comprising a three-pin male connection plug connected at the first end of the power cord.

16. The power cord of claim 1, further comprising a three-pin female connection plug connected at the second end of the power cord.

17. A power cord configured to transmit an alternating electrical current having a frequency of either about 50 hertz or about 60 hertz, consisting essentially of a bundle of first, second, and third carbon conducting wires of substantially the same length, wherein each of the at least first, second, and third carbon conducting wires terminate so as to define first and second ends of the power cord, and wherein each of the first, second, and third carbon conducting wires have respective first, second, and third flexible carbon fiber sheathings, and wherein a flexible plastic tube retains the first, second, and third carbon conducting wires having respective first, second, and third flexible carbon fiber sheathings, and wherein a fourth flexible carbon material sheathing retains the flexible plastic tube, and wherein an outer flexible nylon sheathing retains the fourth flexible carbon material sheathing.

18. (canceled)

19. The power cord of claim 17, further comprising a three-pin male connection plug connected at the first end of the power cord and a three-pin female connection plug connected at the second end of the power cord.
